(19) United States
(12) Patent Application Publication
(10) Pub. No.: US 2021/0309354 A1
(43) Pub. Date: Oct. 7, 2021

(54) SYSTEM AND METHOD FOR PACKAGE TRANSPORTATION

(71) Applicant: MightyFly Inc., Richmond, CA (US)

(72) Inventors: Scott Parker, Richmond, CA (US); Manal Habib, Richmond, CA (US)

(21) Appl. No.: 17/218,032

(22) Filed: Mar. 30, 2021

Related U.S. Application Data
(60) Provisional application No. 63/006,173, filed on Apr. 7, 2020.

(51) Int. Cl. B64C 39/02; B64D 9/00; B64F 1/32; B64C 1/06; B64C 1/20; B64C 3/56; G01G 19/12; G01M 1/30

(52) U.S. Cl. CPC B64C 39/024; B64D 9/00; B64F 1/322; B64C 1/0683; B64C 1/20; G06Q 50/28; G01G 19/12; G01M 1/30; B64C 2201/02; B64C 2201/128; B64C 3/56

(57) ABSTRACT

The invention(s) include embodiments and applications of: a system for package handling, the system including: a flying vehicle comprising a nose portion; a storage region of the flying vehicle; a landing support subsystem coupled to the flying vehicle; one or more thrust generating devices coupled to the flying vehicle 110; a package conveying subsystem configured to interface with the flying vehicle; and a weight and balance detection subsystem comprising a set of sensors coupled to at least one of the flying vehicle and the package conveying subsystem. The system can execute operation modes, associated with loading and unloading of multiple packages, redistributing multiple packages according to weight, and delivering one or more packages to receiving sites.

### CROSS-REFERENCE TO RELATED APPLICATIONS

This application claims the benefit of U.S. Provisional Application No. 63/006,173 filed on 7 Apr. 2020, which is incorporated in its entirety herein by this reference.

### TECHNICAL FIELD

This invention relates generally to the field of flying vehicles, and more specifically to a new and useful system and method for package transportation in the field of flying vehicles.

### BACKGROUND

Current package delivery platforms are subject to various limitations, which can be specific or non-specific to mode of delivery. For instance, ground-based delivery systems involving delivery personnel are subject to inefficiencies in transportation, high physical demand, and weaknesses in security aspects (e.g., risk of theft). Ground-based delivery systems involving delivery vehicles are subject to inefficiencies in transportation, fuel requirements, and weaknesses in security aspects. Aerial delivery platforms are being developed for package delivery; however, such platforms are subject to constraints related to payload capacity, endpoint operations (e.g., in relation to package loading, in relation to package unloading), in-flight operations (e.g., in relation to transportation of packages, in relation to in-air delivery of packages), efficiency aspects, safety aspects (e.g., in relation to safety of entities interacting with such flying vehicles), human interface aspects (e.g., in relation to manual control, semi-autonomous control, and/or autonomous control of aerial delivery vehicle systems), aerodynamic design aspects, and infrastructure requirements (e.g., landing site requirements, catapult system requirements, etc.).

Thus, there is a need in the field of flying vehicles to create a new and useful system and method for package transportation.

### BRIEF DESCRIPTION OF THE FIGURES

FIG. 1 depicts an embodiment of a system for package transportation.

FIG. 2 depicts an embodiment of various operation modes of a system for package transportation.

FIG. 3 depicts a configuration of an embodiment of a system for package transportation.

FIG. 4A depicts a portion (retention elements) of an embodiment of a system for package transportation.

FIG. 4B depicts a portion of an embodiment of a system for package transportation, with respect to preloading of packages with variable weight distributions.

FIGS. 5A and 5B depict embodiments of loading and/or unloading portions of a system for package transportation.

FIG. 6 depicts a configuration of an embodiment of thrust components of a system for package transportation.

FIG. 7 depicts folded and unfolded configurations of an embodiment of thrust components, aerodynamic surfaces, and wings of a system for aerial cargo transportation.

FIGS. 8A-8E depict views of a specific example of a system for package transportation.

FIG. 9 depicts an embodiment of a method for package transportation.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. BENEFITS

The inventions associated with the system and method can confer several benefits over conventional systems and methods, and such inventions are further implemented into many practical applications related to improvements in package delivery.

The invention(s) employ novel flying vehicle design features that promote efficiency in package handling and interactions with human and/or non-human entities, during delivery, flight, and ground operations.

The invention(s) also employ non-traditional systems and methods for package delivery. In particular, the invention(s) implement novel and non-obvious package loading, storing, and unloading systems that can handle multiple packages, with weight and balance management subsystems for ensuring proper loading and/or maintaining weight and balance characteristics (e.g., center of gravity) within suitable ranges during various modes of flying vehicle operation.

In variations, the invention(s) are designed for transport of payloads with variable mass distribution in space. In examples, the payloads can include sets of packages having a total weight of 100 lbs or greater. Alternatively, the payloads can include sets of packages having a total weight less than or equal to 100 lbs.

The invention(s) also employ aerodynamic surfaces configured to improve flight performance (e.g., in relation to range extension, endurance, speed, fuel efficiency, etc.).

The invention(s) also employ safety features configured to separate moving flying vehicle parts from human and/or non-human entities during delivery, flight, and ground operations.

The invention(s) also employ forward thrust elements for increasing longitudinal speed and range of the flying vehicle and for serving other suitable functions.

The invention(s) can also be used to provide automated transmission of delivery-associated notifications, in collaboration with entities associated with a chain of delivery operation phases.

Additionally or alternatively, the system and/or method can confer any other suitable benefit.

### 2. SYSTEM

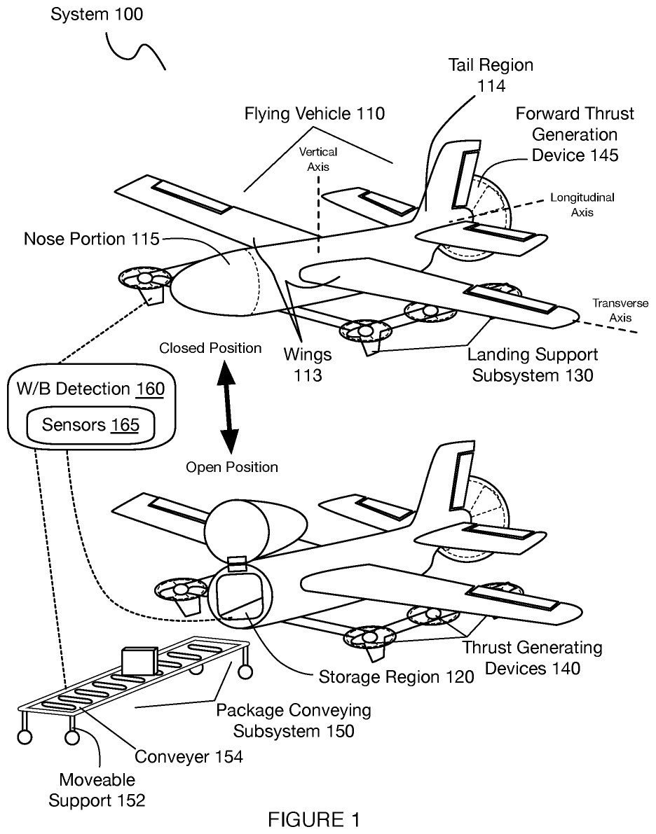

As shown in FIG. 1, an embodiment of a system 100 for package delivery includes: a flying vehicle 110 including a nose portion 115 having an open position and a closed position; a storage region 120 within the flying vehicle 110; a landing support subsystem 130 coupled to the flying vehicle 110; a set of thrust generating devices 140 including a forward thrust generation device 145, the set of thrust generating devices 140 coupled to the flying vehicle 110; a package conveying subsystem 150 configured to interface with the nose portion 115 of the flying vehicle 110; and a weight and balance detection subsystem 160 comprising a set of sensors 165 coupled to at least one of the flying vehicle 110 and the package conveying subsystem 150. In variations, one or more portions of the system 100, including flying vehicle components (e.g., fuselage, wings, fuel system, tail, nose, etc.) can be configured to be modular or non-modular in design.

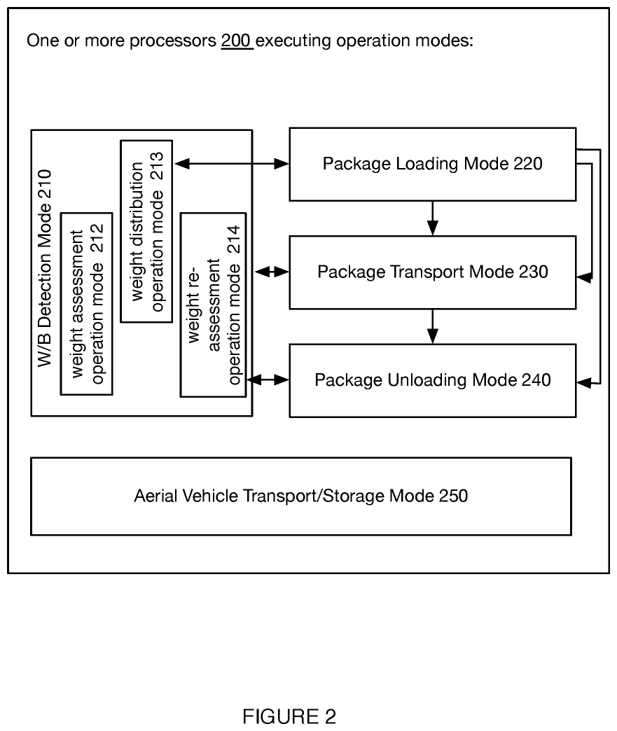

As shown in FIG. 2, embodiments of the system 100 can be configured to execute a set of operation modes including one or more of: a weight and balance detection mode 210, a package loading mode 220, a package transport mode 230, and a package unloading mode 240, and/or a diagnostics/pre-flighting mode configured to assess statuses of one or more flying vehicle subsystems, where various aspects of the system configurations in each mode are further described in Section 2.5 below.

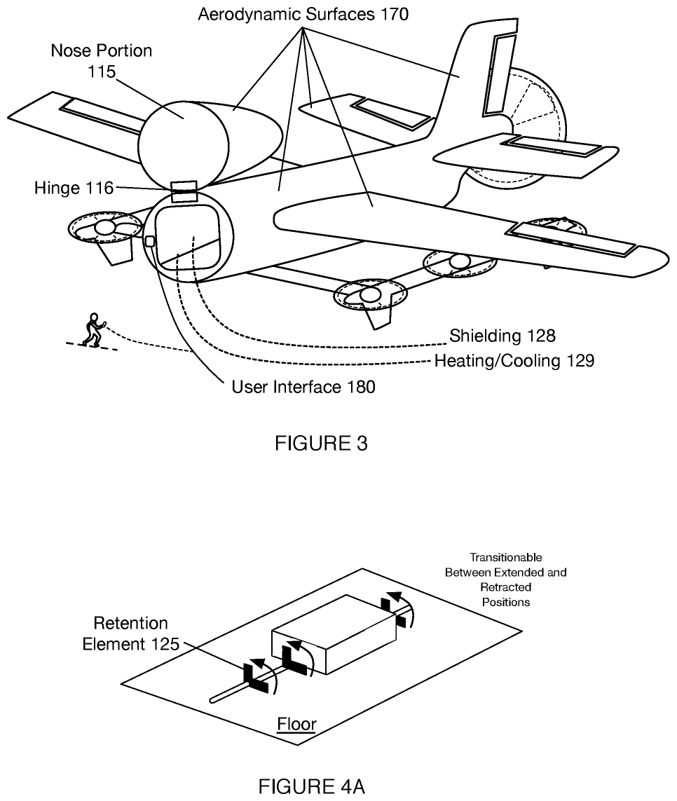

In some embodiments, as shown in FIG. 3, the system 100 can additionally or alternatively include one or more of: a set of surfaces 170 (e.g., fairing) configured to improve aerodynamic performance of the flying vehicle 110; and a user interface 180 including a set of control elements associated with one or more operation modes of the system 100. Additionally or alternatively, as shown in FIG. 3, the user interface 180 can include remote interface elements (e.g., user devices) configured to communicate remotely with flying vehicle subsystems by a wireless and/or wired connection. Furthermore, the system 100 can include intermediate wireless data relay device(s) that connect the system 100 to the cloud such that control of components can be conducted via any suitable and secure devices connected to the internet.

Additionally or alternatively, the system 100 can include architecture and structures for wireless interfaces with remote sensors (e.g., sensors for generating signals in relation to wind parameters, barometric parameters, real-time kinematic (RTK) GPS parameters, etc.), in order to enhance navigation and thus, accuracy in delivery of packages. Additionally or alternatively, system 100 can include architecture and structures for interfaces with unmanned traffic management (UTM) services that provide automated flight approvals and navigation assistance for the flight and delivery of the packages.

The system 100 functions to receive, handle, and facilitate delivery of packages, with aspects configured for loading, storing, and unloading of multiple packages in a manner that accounts for weight and balance considerations. In relation to package delivery, the system 100 functions to operate with aerodynamic efficiency, by employing novel aerodynamic surfaces. The system 100 also functions to provide features intended to improve safety of entities with which the flying vehicle 110 interacts, for instance, by separating moving flying vehicle parts from human and/or non-human entities during delivery, flight, and ground operations. For instance, features can include physical constraints for propellor/turbine components and/or shields, guards, or other elements configured between moving components of the flying vehicle 110 and operators/other entities.

The system 100 can be configured to implement one or more portions of the method(s) described in Section 3 below, but can additionally or alternatively be configured to implement other suitable methods (e.g., related to transportation of non-package entities or objects).

2.1 System—Flying vehicle, Storage, and Landing Support(s)

As shown in FIG. 1, an embodiment of a system 100 for package delivery includes: a flying vehicle 110 including a nose portion 115 having an open position and a closed position; a storage region 120 within the flying vehicle 110; and a landing support subsystem 130 coupled to or otherwise in connected to a portion of the flying vehicle 110. The flying vehicle components function to provide reliable and consistent performance in relation to package handling and delivery, when the flying vehicle 110 is stationary and in motion.

In embodiments, the flying vehicle 110 includes aerodynamic surfaces configured to provide lift and/or control in adjustment of roll (e.g., about a longitudinal axis), pitch (e.g., about a transverse axis), and yaw (e.g., about a vertical axis) orientations of the flying vehicle 110. In variations, such aerodynamic surfaces can include: one or more wing elements (e.g., a set of bilateral wings 113 shown in FIG. 1, other wing configurations), one or more elevator surfaces, one or more tail surfaces (e.g., at tail region 114 shown in FIG. 1), one or more rudder surfaces, one or more ailerons, one or more spoilers, one or more slats, one or more airbrakes, one or more vortex generators, one or more trim surfaces, one or more nose portion elements, one or more fuselage elements, one or more boom elements, and/or other suitable aerodynamic surfaces.

The flying vehicle 110 can be manned or unmanned (e.g., remotely operated, autonomous, semi-autonomous). In variations, the flying vehicle 110 can be classified according to one of a set of groups (e.g., unmanned aerial system tiers, etc.), such as a first group corresponding to flying vehicles having a maximum weight from 0-20 lbs, a normal operating altitude less than 1,200 feet above ground level (AGL), and a speed of less than 100 kts; a second group corresponding to flying vehicles having a maximum weight from 21-55 lbs, a normal operating altitude less than 3,500 feet above ground level (AGL), and a speed of less than 250 kts; a third group corresponding to flying vehicles having a maximum weight less than 1,320 lbs, a normal operating altitude less than flight level 180, and a speed less than 250 kts; a fourth group corresponding to flying vehicles having a maximum weight greater than 1,320 lbs, a normal operating altitude less than flight level 180, and any airspeed; and a fifth group corresponding to flying vehicles having a maximum weight greater than 1,320 lbs, a normal operating altitude greater than flight level 180, and any airspeed. However, the flying vehicle 110 can additionally or alternatively belong to any other category or class of flying vehicles in another classification system.

While this description describes aspects of fixed-wing flying vehicles, multi-copter flying vehicles, quad-plane flying vehicles, vertical-takeoff-and-landing (VTOL) vehicles, and/or electric VTOL (eVTOL) vehicles, the system 100 can additionally or alternatively include components, form factors, and/or control surfaces associated with other flying vehicle types.

The flying vehicle 110 can have a predominating longitudinal axis, along which there is a forward direction and an aft direction, relative to a center of gravity (CG) of the flying vehicle 110. As noted above, the flying vehicle 110 can include a nose portion 115 having an open position and a closed position of operation, where the open position provides access for loading and/or unloading of packages using the package conveying elements described in Section 2.3 below, and the closed position is implemented during storage and/or transport of one or more packages by the flying vehicle.

In relation to transitioning of the nose portion 115 between the open position and the closed position, the flying vehicle 110 can include one or more structures that provide mechanisms for executing the open position and the closed position. In one variation, as shown in FIG. 3, the flying vehicle 110 can include a hinge 116 positioned near a dorsal portion of the nose region of the flying vehicle 110, where the hinge 116 allows the nose portion 115 to transition between open and closed positions. In transitioning the nose portion 115 between the open position and closed position, the nose portion 115 can include one or more actuators (e.g., mechanical actuators, hydraulic actuators, etc.) for opening and closing the nose portion 115. In one variation, the nose portion 115 can include one or more motors (e.g., within the nose portion) coupled to one or more drive shafts, each coupled to a gearbox configured to transform rotational motion into other motion (e.g., by way of elements linking the gearbox to appropriate positions of the nose portion 115). As such, in this and other variations, the hinge 116 can provide a node about which the nose portion 115 can rotate open or rotate closed.

Furthermore, the hinge 116 and associated mechanisms can cooperate to retain the nose portion 115 in the open position, in the closed position, and/or positions intermediate to the open position and the closed position (e.g., at discrete positions, along a continuum between the open position and the closed position). Furthermore, the nose portion 115 can include a locking mechanism (e.g., one or more latches, etc.) configured to reversibly lock the nose portion in the closed position and/or at other positions. Additionally or alternatively, mechanisms associated with the nose portion 115 can be configured for sliding of the nose portion 115 between open and/or closed positions.

As shown in FIG. 1, the flying vehicle 110 includes a storage region 120 configured to receive one or more packages during loading phases of operation, facilitate transport of one or more packages, and deliver one or more packages during unloading phases of operation. The storage region 120 is preferably primarily internal to the flying vehicle, and functions as a cargo bay for receiving, carrying, and allowing removal of packages. In variations, the storage region 120 has a volumetric capacity from 0.25 cubic meters to 50 cubic meters; however, in other variations, the storage region 120 can have another suitable capacity. Additionally or alternatively, the storage region 120 can have a weight capacity for a set of packages having a total weight of greater than 100 lbs., with variable weight distribution; however, in other variations, the storage region 120 can have a weight capacity for a set of packages having a total weight of less than 100 lbs. (e.g., 90 lbs, 80 lbs, etc.) and/or with non-variable weight distribution. The storage region 120 can define a prismatic volume (e.g., with a constant cross section taken transverse to a longitudinal axis of the flying vehicle), or can alternatively define a non-prismatic volume.

The storage region 120 preferably has a substantially planar floor to facilitate reception of packages from the package conveying subsystem 150 described below. In relation to reception of packages, the floor can include elements (e.g., rails, tracks, rollers, a belt, etc.) that facilitate sliding of packages from the package conveying subsystem 150 into the storage region 120, during package loading onto the flying vehicle 110. Additionally or alternatively, the floor of the storage region 120 can have a terminal portion (e.g., entry region close to the nose portion 115) that is aligned with the conveyer 154 and includes features for coupling with the package conveying subsystem 150, such that the storage region 120 can provide a robust mechanism by which packages can be conveyed into the storage region 120 in a reliable manner (e.g., without undesired uncoupling from the package conveying subsystem 150). As described in more detail below, the floor of the storage region 120 can form a substantially continuous surface with the package conveying subsystem 150, when the package conveying subsystem 150 interfaces with and/or couples with the flying vehicle 110. Additionally or alternatively, the storage region 120 can include a subsystem for package relocation (e.g., a gantry coupled to a robotic arm, etc.), for moving/relocating one or more packages after initial loading of the one or more packages onto the flying vehicle 120.

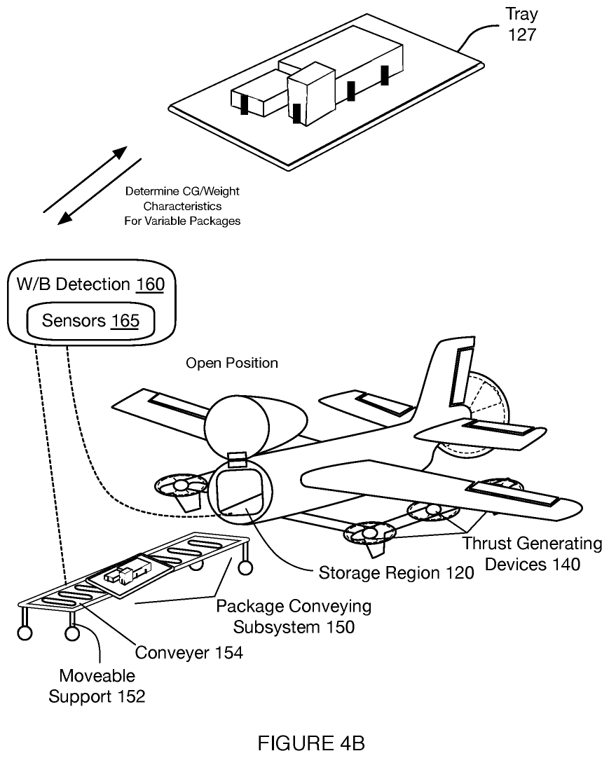

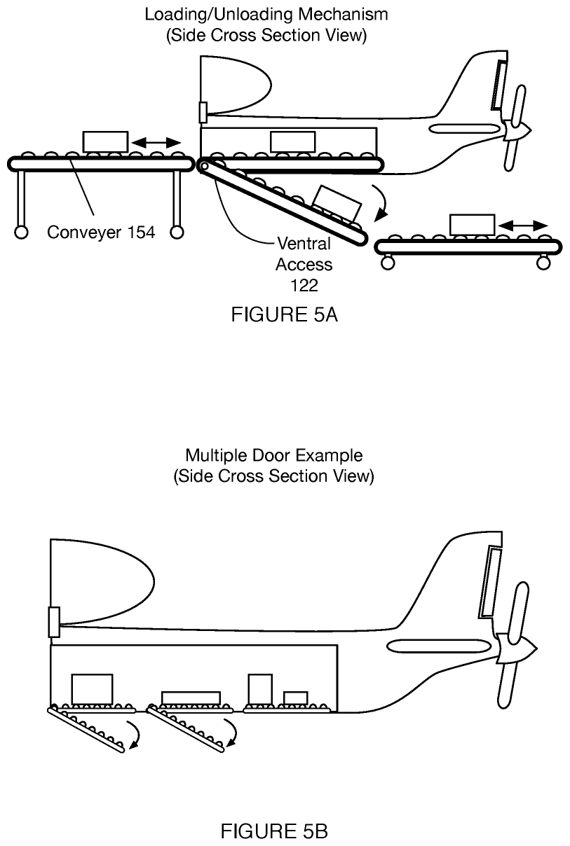

In relation to maintaining positions of the one or more packages at desired locations of the storage region 120, the flying vehicle 110 can include one or more retention elements 125 configured to prevent individual packages or groups of packages from moving away from a desired position. In variations, one of which is shown in FIG. 4, the retention elements can include one or more walls, posts, and/or bars. Furthermore, the retention elements can be fixed in position or re-adjustable. Additionally or alternatively, the retention elements can be retractable (e.g., transitionable between extended and retracted configurations), as shown in FIG. 4A, in order to provide versatility in retention options. Additionally or alternatively, as shown in FIG. 4B, the system 100 can include one or more carrier trays 127 (e.g., pallets) configured to facilitate retention and/or loading efficiency and be loaded onto the flying vehicle 110, where the carrier tray(s) 127 can be loaded with one or more packages in a configuration that accounts for weight and balance considerations, as shown in FIG. 4B. For instance, in some operation modes, the carrier tray(s) can be pre-loaded according to weight assessment, weight distribution (e.g., with respect to center of gravity or other characteristics), and/or weight redistribution operation modes enabled by the weight and balance detection subsystem 160, and the pre-loaded trays can then be loaded onto the storage region 120. In these variations, the carrier tray(s) can be retained in position relative to the flying vehicle 110, with retention of packages in the carrier tray(s) and retention of the carrier tray(s) relative to the flying vehicle 110. However, in other variations, the system 100 can be otherwise configured (e.g., without retention of individual packages).

In some variations, one or more regions of (e.g., sub-regions of, entirety of) the storage region 120 can include shielding components (e.g., shown in FIG. 3) configured to protect contents of the package(s) and/or to prevent characteristics of the package(s) from affecting operation of the flying vehicle. In variations, the shielding can be composed of a material, with suitable morphological characteristics, that provides a barrier against one or more of: thermal energy, electromagnetic energy, chemical energy, radiant energy, nuclear energy, motion (e.g., as a dampener) and any other suitable type of energy. The shielding components can be configured as one or more shells configured to house one or more packages, or can alternatively be configured in another suitable manner.

Additionally or alternatively, in some variations, one or more regions of (e.g., sub-regions of, entirety of) the storage region 120 can include isolated environments with cooling and/or heating subsystems 129 (e.g., shown in FIG. 3), in order to provide temperature controlled environments as appropriate for transport of one or more packages. In one variation, one or more subregions of the storage region 120 can provide cold storage for maintaining one or more packages in a refrigerated or frozen state. Additionally or alternatively, in another variation, one or more subregions of the storage region 120 can maintain one or more packages at room temperature or below a threshold temperature. The heating/cooling subsystems can be configured to account for ambient temperatures outside the flying vehicle 110 and/or within the storage region 120 at altitude, in order to maintain or take advantage of heating/cooling provided by the environment at various altitudes of flight operations.

In related embodiments, one or more regions of (e.g., sub-regions of, entirety of) the storage region 120 can include isolated environments for controlling pressure and/or moisture surrounding one or more packages.

As such, the storage region 120 can, in some variations, be subdivided into multiple compartments to provide suitable environments for different types of packages.

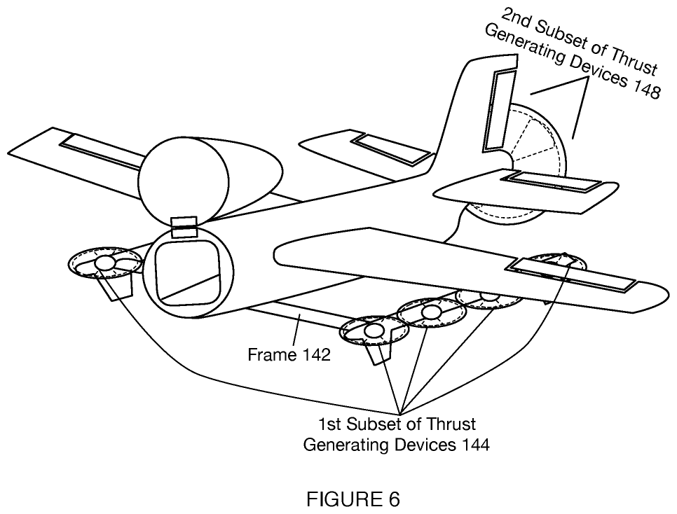

In some variations, the storage region 120 can include one or more alternative access openings (e.g., aside from the open position of the nose region 115), in order to allow unloading and/or loading of packages from the flying vehicle 110. As shown in FIG. 5A, in one variation, the flying vehicle 120 can include another access opening ventral access region 122 at the belly (e.g., ventral region) of the flying vehicle 120 (e.g., with ramp doors), in order to allow unloading of packages from the belly region. Thus, in this variation, the packages can be loaded onto and unloaded from the flying vehicle 120 in a first in, first out configuration. In this variation, the ventral access region 122 can be positioned at an intermediate floor portion of the storage region 122, in order to provide a mechanism by which one or more of the set of packages are unloaded in the package unloading mode. As shown in FIG. 5A, the intermediate floor portion/ventral access region 122 can be rotatably coupled to the flying vehicle by a hinge. The access opening(s) can, however, be configured at other suitable locations of the flying vehicle. For instance, as shown in FIG. 5B, the flying vehicle 120 can include multiple access doors for loading and/or unloading of packages.

While the storage region 120 is described above as internal to the flying vehicle 110, in variations, the storage region 120 can additionally or alternatively include sites external to the flying vehicle 120. For instance, in some variations, the flying vehicle 120 can include external structures (e.g., hard points) to which packages can be reversibly coupled. The external structures can extend from the outermost portion (e.g., skin) of the flying vehicle, or can additionally or alternatively pass through the outermost portion and extend from an internal frame of the flying vehicle, in order to provide robust sites for package loading. In variations, the external structures are positioned near the CG of the flying vehicle 120 (e.g., near wing spars, from the belly, at a dorsal surface, etc.) in order to reduce risk of undesired behavior in stationary or flight modes of the flying vehicle. Additionally or alternatively, in variations, the external structures can be positioned contralaterally about the longitudinal axis of the flying vehicle 120 to provide balance. Additionally or alternatively, the external structures can be positioned anywhere in a manner that does not adversely affect flight or stationary modes of the flying vehicle 120 (e.g., in relation to stalling characteristics, in relation to maneuvering speeds, in relation to speeds associated with maximum loads, in relation to balance when stationary, etc.). In variations including internal and external storage region aspects, the weight and balance detection subsystem 160 described in more detail below can be configured to accommodate packages distributed across internal and/or external sites of the flying vehicle 110.

As shown in FIG. 1, the flying vehicle also includes a landing support subsystem 130, which functions to enable the flying vehicle 110 to land at a landing site, takeoff from a takeoff site, allow the flying vehicle 110 to receive packages from and/or align the flying vehicle 120 with the package conveying subsystem 150 described in more detail below. In variations, the landing support subsystem 130 can include one or more of: a conventional landing gear system (e.g., as in fixed wing aircraft), a nose gear landing system (e.g., as in fixed wing aircraft), skids (e.g., as in rotorcraft), wheels (e.g., as in rotorcraft), skis, floats, and/or any other suitable landing system. Variations of the landing support system 130 can further include fixed components and/or retractable components (e.g., in order to improve performance in flight operation modes, etc.).

The landing support subsystem 130 is configured to land on hard terrain (e.g., paved terrain, grass terrain, dirt terrain, etc.). As such, the landing support subsystem 130 can include elements (e.g., springs, dampening elements, etc.) configured to reduce forces (e.g., G-forces) experienced by the flying vehicle 110 upon/during landing. Additionally or alternatively, the landing support subsystem 130 can be configured to land on non-hard terrain (e.g., soft surfaces, water, etc.). The landing support subsystem 130 can be configured to land on, takeoff from, and operate on substantially flat surfaces, or can additionally or alternatively be configured to land on, takeoff from, and operate on non-planar surfaces and/or moving surfaces (e.g., of an air carrier, of a vehicle configured to travel over water, of a vehicle configured to travel on land, of a vehicle configured to travel by air, etc.). For instance, one or more portions of the landing subsystem 130 can include one or more actuators configured to level the flying vehicle 110 or otherwise align a portion (e.g., storage region 120) of the flying vehicle 110 with a package conveying subsystem 150 component to reduce potential for issues during package loading or unloading.

As shown in FIG. 1, the landing support subsystem 130 can extend from a ventral portion of the flying vehicle 110 (e.g., from supports to which one or more thrust generating devices 140 are coupled). However, in other variations, the landing support subsystem 130 can additionally or alternatively extend from other portions of the flying vehicle 110 (e.g., from undersides of wings, body, etc.). Furthermore, in variations, the landing support subsystem 130 can have multiple supports (e.g., three supports, four supports, greater than four supports, fewer than three supports, etc.), in order to provide stability during ground-based operations. Each support can be individually controllable (e.g., in variations wherein the landing support subsystem 130 is configured to land on non-planar surfaces); however, in other variations, each support may not be individually controllable (e.g., as in all-retract and all-extend gear systems).

The landing support subsystem 130 is further configured in a manner that does not obstruct loading of packages onto or unloading of packages from the flying vehicle. As such, supports of the landing support subsystem 130 are preferably positioned away from the opening(s) of the nose portion 115 of the flying vehicle, and/or any other access sites.

### 2.2 System—Thrust Generation Devices

As shown in FIG. 1, the flying vehicle 110 includes a set of thrust generating devices 140 including a forward thrust generation device 145, which function to, with other power plant aspects, provide thrust for takeoff, hover, landing, fixed-wing operations, transitions between VTOL and fixed-wing or other operation modes, and/or other flight and ground operations. As such, the set of thrust generating devices 140 can be configured to generate forward thrust, vertical thrust, and/or thrust along other suitable vectors defined relative to reference axes of the flying vehicle 110. In relation to the set of thrust generating devices 140, the flying vehicle 110 includes a power plant for generation of power associated with ground and flight operations, where the power plant can include one or more units of one or more of: an electric engine, a hybrid engine, a piston engine (e.g., in-line engine, V-type engine, opposed engine, radial engine, etc.), a turbine engine (e.g., a turbojet engine, a turbofan engine), a pulsejet, a rocket, a diesel engine, and any other suitable power plant system. The power plant can be coupled to an energy source (e.g., battery, fuel system, solar cell, hydrogen fuel cell, etc.) and a cooling system (e.g., forced convection cooling system, liquid cooling system, oil cooling system, etc.) for aircraft performance and operation in flight and/or during ground operations.

Thrust generating devices 140 can be optionally decoupled from the power plant by way of a clutch, transmission, gearbox, or other system. This is useful when starting the power plant, when using the power plant purely to drive an onboard generator and/or when if the ability to operate the power plant in a way that is decoupled from thrust generation (e.g., starting, idling, warming, testing and diagnostics, safety, etc.) is desired. It may also be beneficial to disconnect the power plant if it has failed and an alternative power plant (e.g., electric motor) is then used to power the thrust generating devices 140.

Furthermore, in variations, the set of thrust generating devices 140 can be configured for failsafe operation modes (e.g., with component redundancy), such that the flying vehicle 110 can still fly and/or land safely in the event of a failure of one or more components (e.g., motors, propellers, batteries, etc.).

Each of the set of thrust generating devices 140 is preferably individually controllable, in order to provide fine control of behavior of the flying vehicle 110 on the ground and/or in flight. Alternatively, one or more subsets of the set of thrust generating devices 140 can have controls coupled with other thrust generating devices of the set of thrust generating devices 140.

Each of the set of thrust generating devices 140 can include one or more blades coupled to a shaft coupled (e.g., directly, indirectly, by one or more gearboxes, clutches, joints, etc.) to the power plant(s) (e.g., motor components) of the flying vehicle 120. The one or more blades can be configured as a propeller or other rotating airfoil, that converts energy to generate thrust. The power plant(s) can drive rotational motion of the blade(s) of different thrust generating devices 140 in counterclockwise and/or clockwise modes (e.g., to provide balanced characteristics in relation to angular momentum, etc.), depending on intended flight behavior. In operation, each blade can be fixed in pitch, or can alternatively be adjustable in pitch, in order to allow the propeller to operate in more efficient orientations and change desired thrust characteristics. The blades can be constructed of a synthetic material and/or a natural material, and in variations, can be composed of one or more of (e.g., single material or composite material): a metal (e.g., steel, titanium, aluminum, etc.), a polymer, a wood-derived material, or another suitable material. The material(s) of the blade(s) is/are preferably non-brittle and have suitable mechanical and thermal properties appropriate to intended flight environments.

In variations, each thrust-generating device can include multiple blades (e.g., two blades, three blades, four blades, five blades, more than five blades). The multiple blades of a thrust-generating device can be distributed radially and symmetrically about its respective shaft. Each blade can be identical to the other blades, or can alternatively be non-identical to at least one other blade (e.g. in surface area, in cross section, in other morphological or material aspects). For instance, in some variations, a first blade or subset of blades can have a first morphology (e.g., a first width, a first length, a first surface area, a first cross sectional profile, etc.) and a second blade or subset of blades can have a second morphology (e.g., a second width, a second length, a second surface area, a second cross sectional profile, etc.). The first morphology and the second morphology can function to provide desired airflow characteristics, in relation to drag and induced turbulence (e.g., to reduce audible noise associated with spinning blades). The masses of the blade(s) of a thrust generating device can be configured to have a resultant center of gravity aligned with the shaft, or can alternatively be configured in another manner. Furthermore, in relation to forward thrust, vertical thrust, and/or thrust along another suitable axis, each thrust generating device can have its own configuration of blades optimized for providing thrust in one or more specific directions.

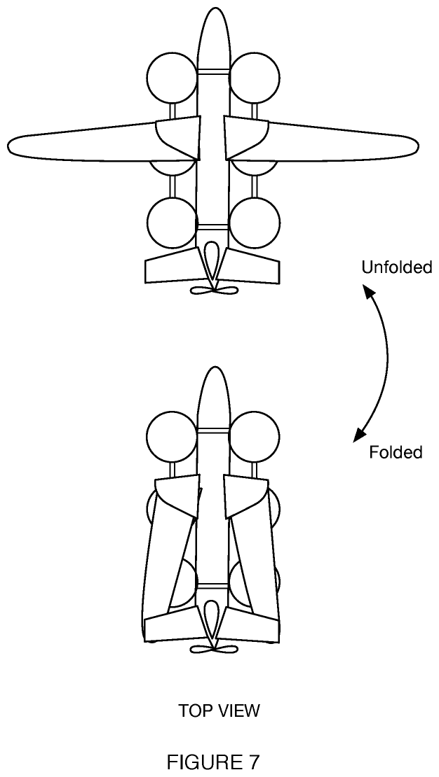

In variations, one of which is shown in FIG. 6, the set of thrust generating devices 140 can have a first subset of thrust generating devices 144 and a second subset of thrust generating devices 148. The first subset of thrust generating devices 144 is coupled to a frame 142 (e.g., ventral frame) extending laterally from a reference axis (e.g., longitudinal axis, vertical axis, transverse axis) of the flying vehicle 120, where the frame orients the first subset of thrust generating devices 144 in a manner that provides primarily upward and downward forces (e.g., for vertical takeoff and landing [VTOL] operations, for other operations). However, thrust generating devices of the first subset 148 can alternatively not be provided in a plane, and/or can be configured to tilt about an axis, such that the first subset of thrust generation devices 144 is not globally configured in a plane and/or blades of each thrust generating device are not aligned with a horizontal plane. In variations, tilted rotors can be configured to provide roll, pitch, and/or yaw control and/or other control aspects, in relation to providing desired thrust vectors.

In variations, one of which is shown in FIG. 6, the first subset of thrust generating devices 144 can include an even number of propellers distributed symmetrically about the longitudinal axis of the flying vehicle 110. However, in other variations, the flying vehicle 110 can include another suitable number of thrust generating devices (e.g., odd number of thrust generating devices) symmetrically or non-symmetrically configured about another reference axis of the flying vehicle 110. In the variation shown in FIG. 6, the first subset of thrust generating devices 144 includes eight propellers, four on each contralateral side of frame 142; however, in other variations, the set of thrust generating devices can include another suitable number of propellers (e.g., 3 propellers, 5 propellers, less than 3 propellers, greater than 5 propellers). As such, the first subset of thrust generating devices 144 can include greater than or equal to four, or less than four thrust generating devices. As shown in FIG. 1, the first subset of thrust generating devices 144 can be coupled to the ventral frame 142 and symmetrically distributed about a longitudinal axis of the flying vehicle 110; however, in other variations, the first subset can be otherwise distributed and configured relative to the flying vehicle 110.

In variations, one of which is shown in FIG. 6, the flying vehicle 110 can include a second subset of thrust generating devices 148, including a forward thrust generation device, which functions to provide thrust along one or more vectors different from thrust vectors of the first subset of thrust generating devices 144. As shown in FIGS. 1 and 6, the forward thrust generating device 145 can be positioned at a portion of the aircraft aft of the CG, in order to position moving blades away from loading and/or unloading positions of the flying vehicle 110, for safety purposes. As such, in a specific example, the forward thrust generating device 145 can be positioned at the tail region 114 of the flying vehicle, as shown in FIG. 1. However, in other variations, the second subset of thrust generating devices 148 can include more than one forward thrust generating devices coupled to other portions of the flying vehicle (e.g., contralaterally, extending from the flying vehicle 110 near the leading edge of each wing, extending from the flying vehicle 110 near the trailing edge of each wing, near the nose portion, etc.). Furthermore, in relation to a hybrid system, the forward thrust generating device(s) 145 can provide thrust, while other power plant aspects (e.g., engines) can additionally be used for thrust (e.g., via a planetary gearbox) in addition to for other purposes (e.g., recharging batteries, etc.) via power take-off devices (e.g., electric motors).

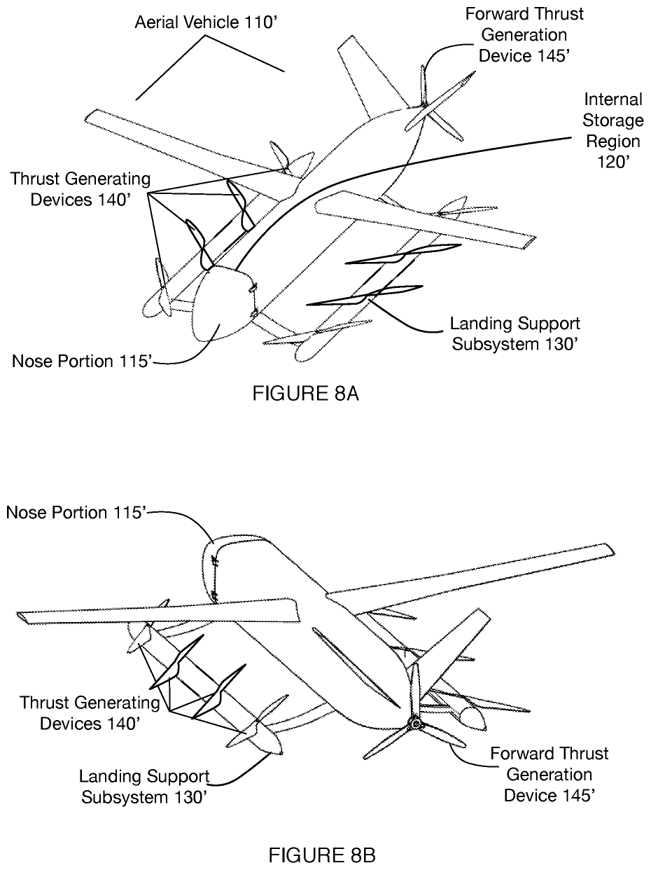

In variations, one or more of extended portions of the flying vehicle 110 (e.g., wings) and/or the set of thrust generating devices 140 can be configured to extend outward away from the fuselage of the flying vehicle 110 and/or to retract inward toward the fuselage of the flying vehicle 110. As such, in some variations, one or which is shown in FIG. 7, one or more of the wings and/or thrust generating devices 140 can fold or rotate inward and/or outward, in order to provide more compact configurations of the flying vehicle 110 (e.g., for transport of the flying vehicle 110), and/or to affect flight characteristics.

In some variations, moving portions (e.g., blades) of the set of thrust generating devices 140 can be surrounded by a cage or other shield (e.g., duct), in order to prevent entities from contacting the moving portions, while still allowing the set of thrust generating devices 140 to provide suitable thrust for operation. However, variations of the set of thrust generating devices 140 can alternatively omit a cage or other shield.

### 2.3 System—Package Conveyer and Weight and Balance Detectors

As shown in FIG. 1, the system 100 also includes a package conveying subsystem iso, which functions to facilitate pre-loading of packages and/or loading of packages onto the flying vehicle 110, and/or to stage the set of packages and interface with the flying vehicle 110. During operation, as described in more detail below, the package conveying subsystem 150 is configured to interface with the nose portion 115 of the flying vehicle 110 in the open position, in order to facilitate transfer of packages from the package conveying subsystem 150 and onto the flying vehicle in a robust and reliable manner.

In the embodiment shown in FIG. 1, the package conveying subsystem 150 includes a moveable support 152 and a conveyer 154 supported by the moveable support 152, where the moveable support 152 positions and/or elevates the conveyer 154 into alignment with the floor of the storage region 120, such that packages can be transferred from the conveyer 154 to the storage region 120. However, as described above, alignment can additionally or alternatively be enabled by the landing support subsystem 130. As described above, the conveyer 154 of the package conveying subsystem 150 can be configured to form a substantially continuous surface with the floor of the storage region 120 during loading of the flying vehicle 120, when the package conveying subsystem 150 interfaces with the flying vehicle 110.

As shown in FIG. 1, the moveable support 152 of the package conveying subsystem 150 can include a set of legs with wheels (e.g., caster wheels) that allow the moveable support 152 to be positioned into alignment with the floor of the storage region 120 of the flying vehicle 110 in the open position. In variations, the one or more of the legs of the moveable support 152 can be adjustable in height, in order to allow the conveyer 154 to align with the floor of the storage region 120 regardless of the terrain on which the flying vehicle 120 and/or the moveable support 152 are situated during loading of packages from the conveyer 154 to the storage region 120. Alignment can be performed automatically (e.g., using optical sensors, using other sensors configured for matching of alignment markers) or manually. However, the legs of the moveable support 152 can alternatively be non-adjustable in height. In relation to coupling between the package conveying subsystem 150 and the storage region 120/flying vehicle 110, the system 100 can be configured to interface the package conveying subsystem 150 with the flying vehicle 110 prior to leveling and/or after levelling the package conveying subsystem 150.

As shown in FIGS. 1 and 5, the conveyer 154 functions to transfer packages onto the floor of the storage region 120. In a first variation, as shown in FIGS. 1 and 5, the conveyer 154 can include a set of rollers that can individually rotate about respective pins, in order to transfer packages from the conveyer 154 to the storage region 120. Each of the set of rollers can be controlled individually, in order to provide a mechanism for controlling movement of individual packages on the conveyer 154 independently of other packages. In another variation, the conveyer 154 can include a belt for transferring packages from the package conveying subsystem 150 to the storage region 120. Surfaces of the conveyer 154 can be textured or otherwise provide a high friction surface (e.g., with gripping material) in order to prevent slipping of packages. Transfer of packages from the conveyer 154 to the storage region 120 can be automatically controlled (e.g., in coordination with a controller that receives weight and balance data from the weight and balance detection subsystem 160 described below), where one or more packages that satisfy weight and balance requirements can be automatically transferred from the conveyer 154 to the storage region 120. Additionally or alternatively, operation of the conveyer 154 can at least partially be manually controlled (e.g., by an operator).

In relation to alignment with the floor of the storage region 120, a portion (e.g., forward facing portion) of the package conveying subsystem 150 can include one or more alignment and/or locking features (e.g., protrusions, recesses, latches, magnetic components, etc.) for at least temporarily fixing the position of the conveyer 154 relative to the floor of the storage region 120. In these embodiments, the open position of the nose portion 115 can be configured to expose alignment and/or locking features that are complementary with those of the package conveying subsystem 150.

In variations, the package conveying subsystem 150 can include a second unit of the moveable support and conveyor, in order to load and/or unload packages from other access openings of the storage region. For instance, the second unit can have shorter legs to receive and unload packages from the belly region of the flying vehicle 120 (e.g., through ramp doors). Additionally or alternatively, the first unit of the package conveying subsystem 150 can be configured to be height adjustable to load and/or unload packages from all access openings into and/or out from the storage region 120.

As shown in FIG. 1, the system 100 can include a weight and balance detection subsystem 160 comprising a set of sensors 165 coupled to at least one of the flying vehicle 110 and the package conveying subsystem 150. The weight and balance detection subsystem 160 functions to provide weight and balance information associated with pre-loading of packages (e.g., onto the package conveying subsystem) and/or packages loaded onto the flying vehicle 110, in a dynamic manner. As such, weight and balance of the flying vehicle 120 can be maintained in suitable ranges during phases of ground and/or flight operations of the flying vehicle 120.

In variations, the set of sensors 165 can include force sensors and/or strain sensors. Additionally or alternatively, the set of sensors 165 can include other types of sensors for indirectly measuring force (e.g., optical sensors configured to detect deformation of a substrate loaded with packages, etc.). For instance, in some variations, center of gravity aspects can be sensed from indirectly or directly measuring relative amounts of fore and aft thrust forces (e.g., of vertical take off and landing components) during hover or other phases of flight. For instance, thrust can be inferred by characterizing relationships between RPM values of fore and aft motors.

In variations, the set of sensors 165 is coupled to the landing support subsystem 130 (e.g., gear legs, wheels, skids, etc.) of the flying vehicle 120, such that the weight and balance detection subsystem 160 can generate weight and balance data of the flying vehicle 110 continuously, in relation to package configurations as packages are loaded onto and/or unloaded from the flying vehicle. Additionally or alternatively, the set of sensors 165 can include sensors coupled to another portion of the flying vehicle 110, such as to the floor of the storage region 120 of the flying vehicle. In these variations, the set of sensors 165 can be configured to account for weight and balance considerations of the flying vehicle 120, with respect to empty weight characteristics, weights of packages loaded internal to the flying vehicle 120, and/or weights of packages secured to external hard points of the flying vehicle 120.

Additionally or alternatively, the set of sensors 165 can include sensors coupled to the package conveying subsystem 150, such as to the moveable support 152 and/or conveyer 154 of the package conveying subsystem 150. Coupling of sensors to the package conveying subsystem 150 can enable operation modes associated with pre-sorting of packages and optimizing configurations of packages prior to loading onto the flying vehicle. In variations, the system 100 can be configured to pre-sort packages based on one or more of: individual weights and/or CGs of packages, global weights and/or CGs of a set of packages (e.g., a pallet), volumes of one or more packages, shapes of one or more packages, delivery sequences of packages, contents of packages (e.g., in relation to environmentally-constrained storage requirements), and/or other variables. As such, the weight and balance detection subsystem 160 can cooperate with a processor and/or controller of the system 100 to assess characteristics of the set of packages and design pre-arranged configurations of packages prior to loading, based upon a set of factors/requirements.

In relation to pre-sorting, the package conveying subsystem 150 can include one or more feeders, which function to receive a subset of packages intended to be loaded onto the flying vehicle 120, and to load them onto the conveyor 154 in a desired sequence associated with weight and balance considerations and/or other considerations.

The weight and balance detection subsystem 150 can also provide data that processor/controller elements of the system 100 can use to control apparatus for positioning and/or repositioning of packages within the storage region 120. For instance, the positioning apparatus can be configured to, based on weight and balance data, readjust positions of one or more packages during operation, based on one or more of: unloading of one or more packages during delivery, pickup of one or more packages or other objects during a mission (e.g., along a delivery route with one or more delivery/pickup events), movement of packages during operation of the flying vehicle, weight and balance requirements during various phases of operation (e.g., flight operations, ground operations) of the flying vehicle, and other considerations.

### 2.4 System—Additional Elements

In some embodiments, the system 100 can additionally or alternatively include a set of surfaces 170 (e.g., fairings) configured to improve aerodynamic performance of the flying vehicle 110. The set of surfaces 170 can be configured to surround individual portions of the flying vehicle 110 (e.g., wing struts, landing supports, etc.), or can alternatively function to surround larger portions of the flying vehicle 110. In variations, the set of surfaces 170 can include a fairing surrounding the storage region 120 (e.g., cargo bay), and one or more fairings surrounding vertical takeoff and landing components of the flying vehicle 120. However, in other variations, the set of surfaces 170 can include fairings for any other suitable portion of the flying vehicle (e.g., pods surrounding portions to which packages are secured external to the flying vehicle).

The set of surfaces 170 can be formed from materials configured with appropriate physical properties (e.g., mechanical properties, thermal properties, electrical properties, etc.) and/or selected based upon manufacturing considerations. In variations, the set of surfaces 170 can be formed from one or more of: metallic materials, composite materials, polymers, and/or other suitable materials.

In variations, the set of surfaces 170 are configured to provide waterproofing for appropriate regions of the flying vehicle (e.g., to prevent water from entering the storage region 120, etc.) and/or can include surface features for routing fluid away from sensitive portions of the flying vehicle 110. However, the set of surfaces 170 can additionally or alternatively be configured to perform other suitable functions (e.g., heating/cooling functions, de-icing functions, functions for increasing drag with speed brakes, etc.).

In some embodiments, the system 100 can additionally or alternatively include a user interface 180 including a set of control elements associated with one or more operation modes of the system 100. The user interface 180 can include control elements that allow a human operator or other entity to perform one or more functions associated with loading of packages onto the flying vehicle 110, unloading of packages from the flying vehicle 110, flight operations, ground operations, and/or any other suitable functions (e.g., modifying operation of thrust generating devices, such as for safety reasons, pre-charging capacitor elements, adjusting operation of power plant components, adjust battery operation states, adjusting braking system states, etc.). The user interface 180 can include indicator elements that indicate system statuses associated with one or more of: electrical systems (e.g., battery statuses), powerplant operation (e.g., fuel levels, temperatures, pressures, etc.), weight and balance characteristics (e.g., within range, out of range, etc.), transitions into and/or from various modes of operation (e.g., nose opening, nose closing, alignment between conveyer and storage region, opening and closing of other access openings into the storage region, flight operation modes, delivery modes, etc.), and/or any other suitable system statuses (e.g., statuses of locks, such as electromechanical locks, at the nose portion 115, statuses of cargo bay doors, etc.).

The system 100 can, however, additionally or alternatively include other elements configured to support operation of the flying vehicle and its associated missions. For instance, the system 100 can include components for performing diagnostics, in relation to generating outputs regarding subsystem statuses (e.g., normal operation, abnormal operation, health reporting, etc.) and/or maintenance requirements for subsystems. Such support operations can be performed within visual line of sight or non-visual line of sight with the flying vehicle 110 (e.g., by way of a connection to the cloud or in another suitable manner).

### 2.5 System—Operation Modes

As described above and shown in FIG. 2, embodiments of the system 100 can be configured to execute a set of operation modes including one or more of: a weight and balance detection mode 210, a package loading mode 220, a package transport mode 230 (e.g., configured for one or more of VTOL operations, fixed-wing operations, transitions between VTOL and fixed-wing operations, and other operations using the one or more thrust generation elements), a package unloading mode 240, and a flying vehicle transport or storage mode 250 (e.g., with a folded configuration). Each of the set of operation modes involves one or more structural configurations of the system, and the system 100 can transition between modes as needed, based on mission requirements. As such, the system 100 can include one or more processors 200 comprising non-transitory media storing instructions that when executed by the one or more processors perform various operation modes.

In the weight and balance detection mode 210, the weight and balance detection subsystem 160 detects weight and balance characteristics (e.g., total weight, center of gravity, etc.) of one or more packages at either or any of the storage region 120, landing support subsystem 130, and the package conveying subsystem 150. Based upon detected weight and balance characteristics, one or more processing components of the system 100 then return one or more outputs and/or execute one or more actions. In more detail, the weight and balance detection mode 210 can include a weight assessment operation mode 212 including architecture for generation of an analysis characterizing weight distribution of a set of packages from outputs of the weight and balance detection subsystem 160, and a weight distribution operation mode 213 in which the set of packages is redistributed in space, according to the analysis, at least at one of the package conveying subsystem 150 (e.g., at conveyer 154, at tray 127, etc.) and the storage region 120 of the flying vehicle 110. Redistribution can be performed automatically (e.g., with robotic apparatus configured to re-distribute individual packages in an optimized manner). However, re-distribution can alternatively be performed manually.

In variations, returned outputs associated with the analysis can be associated with one or more of: weight and balance characteristics within acceptable range, weight and balance characteristics outside of acceptable range, other analyses derived from weight and balance characteristics, reports indicating recommended loading configurations for a set of packages, computer readable instructions configured to be executed by controllers of the package conveying subsystem 150 and/or storage region 120 for loading and/or unloading of packages, computer readable instructions configured to be executed by controllers of the storage region 120 for positioning and/or repositioning of packages within the storage region 120 (e.g., as packages are loaded onto or unloaded from the storage region 120), and/or any other suitable outputs.

In variations, executed actions can include one or more of: controlling conveying elements of the package conveying subsystem 150 and/or portion (e.g., floor, level, overhead portion, etc.) of the storage region 120 for transfer of one or more packages to/from the storage region 120, repositioning of packages within the storage region 120 (e.g., as packages are loaded onto or unloaded from the storage region 120), preventing loading of packages onto the flying vehicle (e.g., if weight and balance characteristics are out of range), and/or any other suitable action.

The weight and balance detection mode 210 can be executed during pre-loading of packages, during loading of packages, during ground operations of the flying vehicle 110, during flight operations of the flying vehicle 110, during delivery operations of the flying vehicle 110, and/or at any other suitable time.

In the package loading mode 220, the nose portion 115 of the flying vehicle is transitioned to the open position, the conveyer 154 is aligned with the floor (or other suitable portion) of the storage region 120 and one or more conveying elements (e.g., rollers, belts) of the conveyer 154 is transitioned to move packages in a forward direction to the storage region 120. In relation to the package loading mode 220, components at the floor of the storage region 120 can additionally or alternatively be configured to facilitate reception of packages (e.g., with conveying elements within the storage region 120). Additionally or alternatively, package positioning apparatus of the storage region 120 can be configured to re-position packages as needed. Additionally or alternatively, retention elements within the storage region can be configured to transition (e.g., extend outward, rotate outward, etc.) to a configuration for maintaining positions and/or preventing shifting of packages.

The package loading mode 220 can be executed post pre-loading of packages and at any time when the flying vehicle 110 is intended to receive packages for storage or transport.

In the package transport mode 230, the package conveying subsystem 150 is moved away from the flying vehicle 110, the nose portion 115 of the flying vehicle is transitioned to the closed position, and the flying vehicle 110 is transitioned into modes associated with ground movement and/or flight (e.g., VTOL operations, fixed-wing operations, transitions between VTOL and fixed-wing operations, etc.), for transport of one or more packages. In relation to the package transport mode 230, components of the storage region 120 can additionally or alternatively be configured to facilitate re-positioning of packages (e.g., as packages are delivered, due to weight and balance changes of the flying vehicle, due to operation modes of the flying vehicle, etc.). In the package transport mode 230, retention elements within the storage region can be configured to maintain configurations for maintaining positions and/or preventing shifting of packages.

The package transport mode 230 can be executed subsequent to instances of the package loading mode 220 and at any time when the flying vehicle 220 is intended to transport packages to a delivery or storage site.

In the package unloading mode 240, portions of the flying vehicle 110 configured for unloading can be transitioned to open positions and/or package release modes, and one or more packages can be released from the storage region 120 of the flying vehicle 110. In variations, one or more of the nose portion 115 and other access openings (e.g., ramp doors at the belly of the flying vehicle 110, etc.) can be transitioned to open positions for allowing packages to be removed or transferred from the storage region 120. In the package unloading mode 240, retention elements within the storage region can be configured to return to retracted configurations as packages are delivered from the flying vehicle 110, and/or maintain configurations for maintaining positions and/or preventing shifting of packages that are still onboard the flying vehicle 110.

The package unloading mode 240 can be executed in association with in-air delivery of one or more packages (e.g., in flight modes, in hover modes, etc.) and/or delivery of one or more packages when the flying vehicle 110 is at a landing site and/or in contact with the ground. In relation to in-air delivery, the system 100 can be configured to drop packages (e.g., through openings on or along the belly of the flying vehicle, etc.) while keeping the flying vehicle 110 airborne.

Furthermore, in relation to the weight and balance detection mode 210, the one or more processors 200 can further include non-transitory media storing instructions that when executed by the one or more processors 200 perform a weight reassessment operation mode 214 when at least one selected package of the set of packages is delivered from the storage region 120, in coordination with the package unloading mode 240. In one such variation, in the weight reassessment operation mode 214, the set of packages can be unloaded from the storage region 120 onto the package conveying subsystem (e.g., conveyer 154, tray 127, etc.), and a selected package can be delivered to the recipient. Then, the system 100 can transition to the weight re-assessment operation mode 214 for generation of an updated analysis characterizing remaining packages of the set of packages, and remaining packages of the set of packages are re-loaded into the storage region in an optimized manner.

The system 100 can, however, be configured to transition to other states, in order to execute other modes of operation.

### 2.6 System—Specific Example

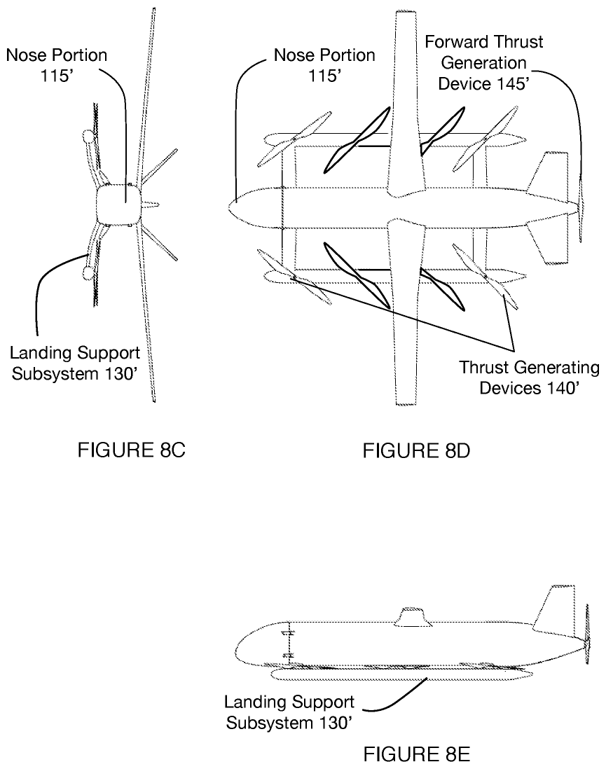

FIGS. 8A-8E depict views of a specific example of a flying vehicle 110′ for package transportation. FIG. 8A depicts an isometric view from the top front of the flying vehicle 110′. FIG. 8B depicts an isometric view from the top back of the flying vehicle 110′. FIG. 8C depicts a front view of the flying vehicle 110′. FIG. 8D depicts a top view of the flying vehicle 110′. FIG. 8E depicts a side view of the flying vehicle 110′. As shown in FIGS. 8A-8E, the flying vehicle 110′ includes a nose portion 115′ having an open position and a closed position; a storage region 120′ within the flying vehicle 110′ (accessible by at least nose portion 115′); a landing support subsystem 130′ coupled to the flying vehicle 110′; and a set of thrust generating devices 140′ including a forward thrust generation device 145′, the set of thrust generating devices 140′ coupled to the flying vehicle 110′. Variations of the specific example can additionally or alternatively include other embodiments, variations, and examples of system elements described above.

### 3. METHOD

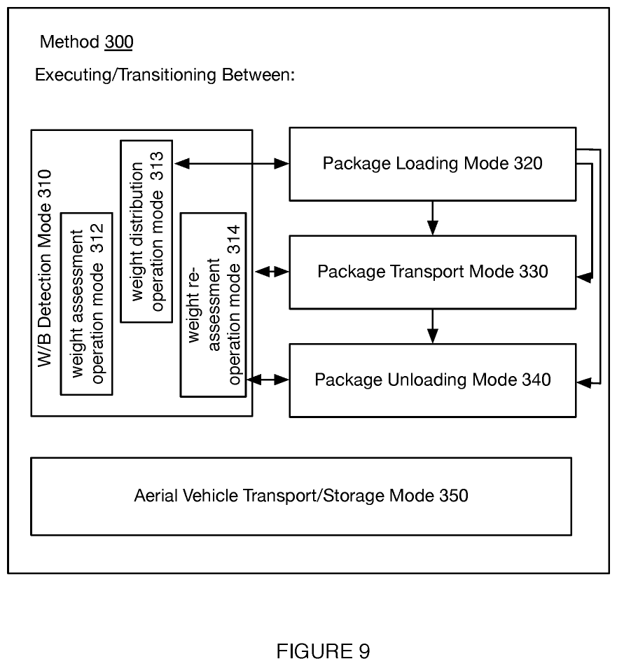

As shown in FIG. 9, an embodiment of a method 300 for package delivery includes executing one or more of, or transitioning a flying vehicle system between one or more of: a weight and balance detection mode 310, a package loading mode 320, a package transport mode 330 (e.g., configured for one or more of VTOL operations, fixed-wing operations, transitions between VTOL and fixed-wing operations, and other operations), a package unloading mode 340, a flying vehicle transport or storage mode 350 (e.g., with a folded configuration).

The method 300 functions to receive, handle, and facilitate delivery of packages, with aspects configured for loading, storing, and unloading of multiple packages in a manner that accounts for weight and balance considerations. In relation to package delivery, the method 300 functions to provide an aerodynamically efficient solution to package transport, by employing novel aerodynamic surfaces. The method 300 also functions to provide features intended to improve safety of entities with which the flying vehicle interacts, for instance, by separating moving flying vehicle parts from human and/or non-human entities during delivery, flight, and ground operations.

As shown in FIG. 9, the weight and balance detection mode 310 includes detecting weight and balance characteristics (e.g., total weight, center of gravity, etc.) of one or more packages at either or any of the storage region, landing support subsystem, and the package conveying subsystem. Based upon detected weight and balance characteristics, the weight and balance detection mode includes returning one or more outputs and/or executing one or more actions. Returning outputs can include performing a weight assessment operation mode 312 including generating an analysis characterizing weight distribution of a set of packages from outputs of the weight and balance detection subsystem, and a weight distribution operation mode 313 including redistributing the set of packages in space, according to the analysis, at least at one of the package conveying subsystem (e.g., at conveyer, at tray, etc.) and the storage region of the flying vehicle 110. Redistribution can be performed automatically (e.g., with robotic apparatus configured to re-distribute individual packages in an optimized manner). However, re-distribution can alternatively be performed manually.

In variations, returned outputs associated with the analysis can be associated with one or more of: weight and balance characteristics within acceptable range, weight and balance characteristics outside of acceptable range, other analyses derived from weight and balance characteristics, reports indicating recommended loading configurations for a set of packages, computer readable instructions configured to be executed by controllers of the package conveying subsystem and/or storage region for loading and/or unloading of packages, computer readable instructions configured to be executed by controllers of the storage region for positioning and/or repositioning of packages within the storage region (e.g., as packages are loaded onto or unloaded from the storage region), and/or any other suitable outputs.

In variations, executed actions can include one or more of: controlling conveying elements of the package conveying subsystem and/or portion (e.g., floor, level, overhead portion, etc.) of the storage region for transfer of one or more packages to/from the storage region, repositioning of packages within the storage region 120 (e.g., as packages are loaded onto or unloaded from the storage region), preventing loading of packages onto the flying vehicle (e.g., if weight and balance characteristics are out of range), and/or any other suitable action.

The method 300 can include executing the weight and balance detection mode 310 can during pre-loading of packages, during loading of packages, during ground operations of the flying vehicle, during flight operations of the flying vehicle, during delivery operations of the flying vehicle, and/or at any other suitable time.

In executing the package loading mode 320, the method 300 can include transitioning the nose portion of the flying vehicle to the open position, and aligning the conveyer with the floor (or other suitable portion) of the storage region. Then, one or more conveying elements (e.g., rollers, belts) of the conveyer can be transitioned to move packages in a forward direction to the storage region. In relation to the package loading mode 320, components at the floor of the storage region can additionally or alternatively be configured to facilitate reception of packages (e.g., with conveying elements within the storage region). Additionally or alternatively, package positioning apparatus of the storage region can be configured to re-position packages as needed. Additionally or alternatively, retention elements within the storage region can be configured to transition (e.g., extend outward, rotate outward, etc.) to a configuration for maintaining positions and/or preventing shifting of packages.

Executing the package loading mode 320 can be performed post pre-loading of packages and at any time when the flying vehicle is intended to receive packages for storage or transport.

In executing the package transport mode 330, the method 300 can include moving the package conveying subsystem away from the flying vehicle, and transitioning the nose portion of the flying vehicle to the closed position. The flying vehicle can be transitioned into modes associated with ground movement and/or flight (e.g., VTOL operations, fixed-wing operations, transitions between VTOL and fixed-wing operations, etc.), for transport of one or more packages. In relation to the package transport mode 330, components of the storage region can additionally or alternatively be configured to facilitate re-positioning of packages (e.g., as packages are delivered, due to weight and balance changes of the flying vehicle, due to operation modes of the flying vehicle, etc.). In the package transport mode, retention elements within the storage region can be configured to maintain configurations for maintaining positions and/or preventing shifting of packages.

The package transport mode 330 can be executed subsequent to instances of the package loading mode 320 and at any time when the flying vehicle 320 is intended to transport packages to a delivery or storage site.

In executing the package unloading mode 340, the method 300 can include transitioning portions of the flying vehicle configured for unloading to open positions and/or package release modes, and one or more packages can be released from the storage region of the flying vehicle. In variations, one or more of the nose portion and other access openings (e.g., ramp doors at the belly of the flying vehicle, etc.) can be transitioned to open positions for allowing packages to be removed or transferred from the storage region. In the package unloading mode 340, retention elements within the storage region can be configured to return to retracted configurations as packages are delivered from the flying vehicle, and/or maintain configurations for maintaining positions and/or preventing shifting of packages that are still onboard the flying vehicle.

The package unloading mode 340 of the method can be executed in association with in-air delivery of one or more packages (e.g., in flight modes, in hover modes, etc.) and/or delivery of one or more packages when the flying vehicle 110 is at a landing site and/or in contact with the ground. In relation to in-air delivery, the system 100 can be configured to drop packages (e.g., through openings on or along the belly of the flying vehicle, etc.) while keeping the flying vehicle airborne.

Furthermore, in relation to the weight and balance detection mode 310, the method 300 can further include performing a weight reassessment operation mode 314 when at least one selected package of the set of packages is delivered from the storage region, in coordination with the package unloading mode 340. In one such variation, in the weight reassessment operation mode 314, the set of packages can be unloaded from the storage region onto the package conveying subsystem (e.g., conveyer, tray, etc.), and a selected package can be delivered to the recipient. Then, the method 300 can include transitioning to the weight re-assessment operation mode 314 for generation of an updated analysis characterizing remaining packages of the set of packages, and remaining packages of the set of packages are re-loaded into the storage region in an optimized manner.

The method 300 can, however, include steps for transitioning to other states, in order to execute other modes of operation.

Embodiments, variations, and examples of one or more components of the system 100 described above can implement one or more embodiments, variations, and examples of the method 300. However, the method 300 can additionally or alternatively be implemented by other suitable systems.

### 4. CONCLUSIONS

The FIGURES illustrate the architecture, functionality and operation of possible implementations of systems, methods and computer program products according to preferred embodiments, example configurations, and variations thereof. In this regard, each block in the flowchart or block diagrams may represent a module, segment, or portion of code, which comprises one or more executable instructions for implementing the specified logical function(s). It should also be noted that, in some alternative implementations, the functions noted in the block can occur out of the order noted in the FIGURES. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As a person skilled in the art will recognize from the previous detailed description and from the figures and claims, modifications and changes can be made to the preferred embodiments of the invention without departing from the scope of this invention defined in the following claims.

What is claimed is:

1. A system for package handling, the system comprising:
A flying vehicle comprising a nose portion, a set of bilateral wings, a ventral frame, and a tail region;
a storage region of the flying vehicle, the storage region accessible at least in part through the nose portion and comprising a volumetric capacity and a weight capacity for receiving a set of packages;
a set of thrust generating devices positioned inferior and posterior to access locations of the storage region, the set of thrust generating devices comprising a first subset supporting a vertical takeoff and landing (VTOL) operation mode distributed across the ventral frame and a second subset comprising a forward thrust generation device positioned at the tail region;
a package conveying subsystem configured to stage the set of packages and interface with the flying vehicle;
a weight and balance detection subsystem comprising a set of sensors coupled to at least one of the flying vehicle and the package conveying subsystem; and
one or more processors comprising non-transitory media storing instructions that when executed by the one or more processors perform:
a weight assessment operation mode comprising generation of an analysis characterizing weight distribution of the set of packages from outputs of the weight and balance detection subsystem,
a weight distribution operation mode in which the set of packages is redistributed in space, according to the analysis, at least at one of the package conveying subsystem and the storage region of the flying vehicle,
a package loading mode in which one or more of the set of packages is delivered from the package conveying subsystem to the storage region of the flying vehicle, and
a package unloading mode in which one or more of the set of packages is delivered from the storage region.

2. The system of claim 1, wherein the nose portion is transitionable between an open position and a closed position.

3. The system of claim 2, wherein the package conveying subsystem comprises a movable support and a conveyer supported by the movable support,
wherein in the package loading mode, the conveyer is aligned with and coupled to a terminal floor portion of the storage region, with the nose portion of the flying vehicle in the open position.

4. The system of claim 1, wherein the flying vehicle further comprises a ventral access region, comprising an intermediate floor portion of the storage region, from which one or more of the set of packages are unloaded in the package unloading mode, wherein the intermediate floor portion is rotatably coupled to the flying vehicle by a hinge.

5. The system of claim 1, wherein the first subset of thrust generating devices comprises greater than four thrust generating devices coupled to the ventral frame and symmetrically distributed about a longitudinal axis of the flying vehicle.

6. The system of claim 1, wherein the weight and balance detection subsystem is coupled to the package conveying subsystem, and wherein, in the weight distribution operation mode, the package conveying subsystem redistributes the set of packages in space prior to transitioning of the system to the package loading mode.

7. The system of claim 1, wherein the one or more processors further comprise non-transitory media storing instructions that when executed by the one or more processors perform a weight reassessment operation mode when at least one selected package of the set of packages is delivered from the storage region.

8. The system of claim 7, wherein in the weight reassessment operation mode, the set of packages is unloaded from the storage region onto the package conveying subsystem, the at least one selected package is delivered from the storage region, the system transitions to the weight assessment operation mode for generation of an updated analysis characterizing remaining packages of the set of packages, and remaining packages of the set of packages are re-loaded into the storage region.

9. The system of claim 1, wherein the weight capacity of the storage region is greater than 100 lbs.

10. A system for package handling, the system comprising:
A flying vehicle comprising a nose portion, a wing, a ventral frame, and a tail region;
a storage region of the flying vehicle, the storage region accessible at least in part through the nose portion and comprising a volumetric capacity for receiving a set of packages;
a set of thrust generating devices coupled to the flying vehicle, the set of thrust generating devices comprising a first subset supporting a vertical takeoff and landing (VTOL) operation mode and a second subset comprising a forward thrust generation device;
a package conveying subsystem configured to stage the set of packages and interface with the flying vehicle;
a weight and balance detection subsystem comprising a set of sensors coupled to at least one of the flying vehicle and the package conveying subsystem; and
one or more processors comprising non-transitory media storing instructions that when executing by the one or more processors perform:
a weight distribution operation mode in which the set of packages is redistributed in space, at least at one of the package conveying subsystem and the storage region of the flying vehicle, and
a package loading mode in which one or more of the set of packages is delivered from the package conveying subsystem to the storage region of the flying vehicle.

11. The system of claim 10, the first subset of thrust generating devices is distributed across the ventral frame and the forward thrust generation device is positioned at the tail region of the flying vehicle.

12. The system of claim 10, wherein the first subset of thrust generating devices comprises greater than four thrust generating devices coupled to the ventral frame and symmetrically distributed about a longitudinal axis of the flying vehicle.

13. The system of claim 10, wherein the flying vehicle further comprises a set of bilateral wings transitionable between a folded configuration and an unfolded configuration.

14. The system of claim 10, wherein the nose portion is transitionable between an open position and a closed position.

15. The system of claim 14, wherein the package conveying subsystem comprises a movable support and a conveyer supported by the movable support,
wherein in the package loading mode, the conveyer is aligned with and coupled to a terminal floor portion of the storage region, with the nose portion of the flying vehicle in the open position.

16. The system of claim 10, wherein the weight and balance detection subsystem is coupled to the package conveying subsystem, and wherein, in the weight distribution operation mode, the package conveying subsystem redistributes the set of packages in space prior to transitioning of the system to the package loading mode.

17. The system of claim 10, wherein the one or more processors further comprise non-transitory media storing instructions that when executed by the one or more processors perform:
a weight assessment operation mode comprising generation of an analysis characterizing weight distribution of the set of packages, and
a weight reassessment operation mode when at least one selected package of the set of packages is delivered from the storage region.

18. The system of claim 17, wherein in the weight reassessment operation mode, the set of packages is unloaded from the storage region onto the package conveying subsystem, the at least one selected package is delivered from the storage region, the system transitions to the weight assessment operation mode for generation of an updated analysis characterizing remaining packages of the set of packages, and remaining packages of the set of packages are re-loaded into the storage region.

19. The system of claim 10, wherein the one or more processors further comprise non-transitory media storing instructions that when executed by the one or more processors perform: a package unloading mode in which one or more of the set of packages is delivered from the storage region through at least one of a) the nose portion in the open position and b) a ventral access region, comprising an intermediate floor portion of the storage region.

20. The system of claim 10, wherein the weight capacity of the storage region is greater than 100 lbs.
